(19) United States
(12) Patent Application Publication
(10) Pub. No.: US 2025/0337518 A1
(43) Pub. Date: Oct. 30, 2025

(54) COMMUNICATION NETWORK DEVICE AND RATE ADJUSTMENT METHOD

(71) Applicant: Realtek Semiconductor Corporation, Hsinchu (TW)

(72) Inventors: Yu-Tung LIAO, Hsinchu (TW); Wen-En LI, Hsinchu (TW); Chung-Nan CHENG, Hsinchu (TW); Ming-Jie GUO, Hsinchu (TW); ChengHsien LI, Hsinchu (TW); PingI CHANG, Hsinchu (TW); Hung Wei WENG, Hsinchu (TW)

(21) Appl. No.: 19/091,841

(22) Filed: Mar. 27, 2025

Related U.S. Application Data
(60) Provisional application No. 63/638,427, filed on Apr. 25, 2024.

(30) Foreign Application Priority Data
Dec. 5, 2024 (TW) 113147324

(51) Int. Cl. H04L 1/00

(52) U.S. Cl. CPC H04L 1/0002; H04L 1/0015

(57) ABSTRACT

A communication network device includes at least one first connection port and a core controller. The core controller is coupled to the at least one first connection port. The core controller includes a noise monitor and a rate controller. The noise monitor is configured to monitor an environmental noise for the at least one first connection port to generate a noise result. The rate controller is configured to adjust a connection rate of the at least one first connection port according to the noise result.

### RELATED APPLICATIONS

This application claims priority to U.S. Provisional Application Ser. No. 63/638,427, filed Apr. 25, 2024 and Taiwanese Application Serial Number 113147324, filed Dec. 5, 2024, which is herein incorporated by reference.

### BACKGROUND

### Technical Field

The present disclosure relates to communication network technology. More particularly, the present disclosure relates to a communication network device and a rate adjustment method that can automatically adjust the connection rate.

### Description of Related Art

With development of technology, various communication network technology and various communication network devices are developed. For example, multiple users can use their electronic devices to participate in an online conference through communication network connections. However, these connections through the communication network by multiple users will cause alien port crosstalk noise (APCN). Noise is a key factor affecting connection quality of the communication network.

### SUMMARY

Some aspects of the present disclosure are to provide a communication network device. The communication network device includes at least one first connection port and a core controller. The core controller is coupled to the at least one first connection port. The core controller includes a noise monitor and a rate controller. The noise monitor is configured to monitor an environmental noise for the at least one first connection port to generate a noise result. The rate controller is configured to adjust a connection rate of the at least one first connection port according to the noise result.

Some aspects of the present disclosure are to provide a rate adjustment method. The rate adjustment method includes following operations: monitoring, by a noise monitor in a core controller in a communication network device, an environmental noise for at least one first connection port to generate a noise result; and adjusting, by a rate controller in the core controller, a connection rate of the at least one first connection port according to the noise result.

### BRIEF DESCRIPTION OF THE DRAWINGS

The disclosure can be more fully understood by reading the following detailed description of the embodiment, with reference made to the accompanying drawings as follows:

FIG. 1 is a schematic diagram of a communication network system according to some embodiments of the present disclosure.

FIG. 2 is a flow diagram of a rate adjustment method according to some embodiments of the present disclosure.

FIG. 3 is a schematic diagram of a plurality of threshold values according to some embodiments of the present disclosure.

FIG. 4 is a schematic diagram of a plurality of threshold values according to some embodiments of the present disclosure.

FIG. 5 is a flow diagram of a rate adjustment method according to some embodiments of the present disclosure.

FIG. 6 is a schematic diagram of how to determine the threshold values for the communication network system in FIG. 1 according to some embodiments of the present disclosure.

### DETAILED DESCRIPTION

In the present disclosure, “connected” or “coupled” may refer to “electrically connected” or “electrically coupled.” “Connected” or “coupled” may also refer to operations or actions between two or more elements.

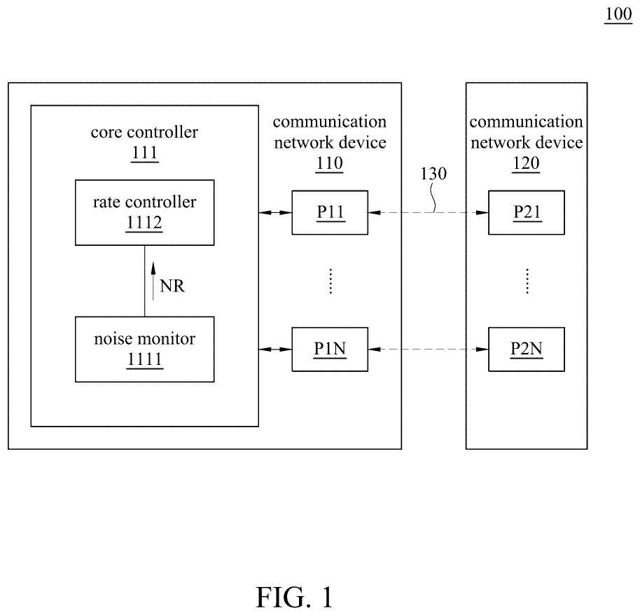

Reference is made to FIG. 1. FIG. 1 is a schematic diagram of a communication network system 100 according to some embodiments of the present disclosure. The communication network system 100 can be applied in various communication network environments.

As illustrated in FIG. 1, the communication network system 100 includes a communication network device 110 and a communication network device 120. The communication network device 120 can be connected to the communication network device 110 through a plurality of cables 130.

The communication network device 110 includes at least one connection port (FIG. 1 illustrates a plurality of connection ports P11-P1N) and a core controller 111. The communication network device 110 can further include other circuits or other elements, but these other circuits or other elements are omitted in FIG. 1 for simplicity.

The communication network device 120 includes at least one connection port (FIG. 1 illustrates a plurality of connection ports P21-P2N). Similarly, the communication network device 120 can further include other circuits or other elements, but these other circuits or other elements are omitted in FIG. 1 for simplicity.

The core controller 111 is coupled to the connection ports P11-P1N. The connection ports P11-P1N are coupled to first terminals of the cables 130 respectively. Second terminals of the cables 130 are coupled to the connection ports P21-P2N respectively. The connection ports P11-P1N can be called as device-under test (DUT) connection ports, and the connection ports P21-P2N can be called as linked partner (LP) connection ports.

In the example of FIG. 1, the communication network device 110 can be a network switch, and the communication network device 120 can be another network switch. In some other examples, the connection ports P21-P2N can be integrated with the communication network device 110 into a network switch.

Taking an online conference as an example, multiple users can connect their electronic devices to the connection ports P21-P2N so as to participate in the online conference. However, these connections through the communication network by multiple users will cause environmental noise. The environmental noise is, for example, alien port crosstalk noise (APCN).

The core controller 111 includes a noise monitor 1111 and a rate controller 1112. The noise monitor 1111 is coupled to the rate controller 1112. In practical applications, the noise monitor 1111 can be implemented by hardware circuits, the rate controller 1112 can be implemented by firmware or software running on a processor or implemented by hardware circuits, but the present disclosure is not limited thereto.

The noise monitor 1111 can monitor environmental noise for each of the connection ports P11-P1N and quantify the monitored environmental noise to generate a noise result NR, and transmit the noise result NR to the rate controller 1112. In one embodiment, the rate controller 1112 can generate corresponding threshold values according to the quantified noise result NR, and the rate controller 1112 can use these threshold values to determine whether to increase or decrease the current connection rate. In other words, the rate controller 1112 can adjust the connection rate of each of the connection ports P11-P1N according to the noise result NR. In other words, the communication network device 110 can adjust the connection rate in real time according to the environmental noise.

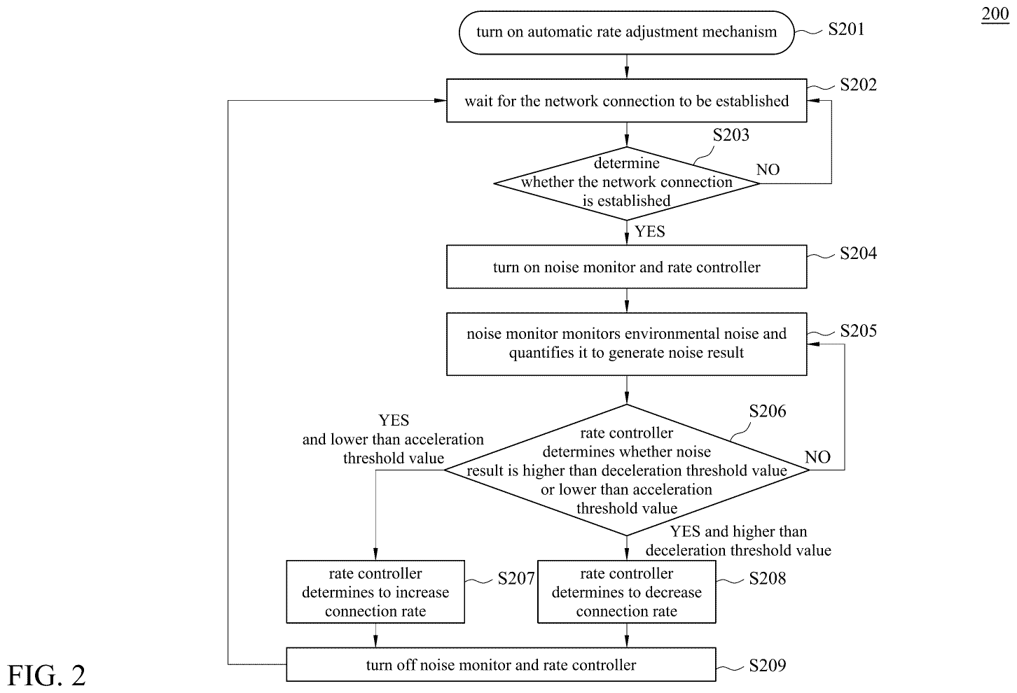

Details about operations of the noise monitor 1111 and the rate controller 1112 are described in following paragraphs with reference to FIG. 2.

References are made to FIG. 1 and FIG. 2. FIG. 2 is a flow diagram of a rate adjustment method 200 according to some embodiments of the present disclosure.

In some embodiment, the rate adjustment method 200 can be applied to the communication network system 100, but the present disclosure is not limited thereto. For better understanding, the rate adjustment method 200 is described in the following paragraphs with reference to the communication network system 100 and the connection port P11 is taken as an example. Other connection ports have similar contents.

As illustrated in FIG. 2, the rate adjustment method 200 includes operation S201, operation S202, operation S203, operation S204, operation S205, operation S206, operation S207, operation S208, and operation S209.

In operation S201, automatic rate adjustment mechanism of the communication network device 110 is turned on. In applications, the automatic rate adjustment mechanism can be turned on automatically when the communication network device 110 is turned on, or the automatic rate adjustment mechanism can be turned on manually by a user.

In operation S202, it waits for the network connection to be established. For example, the communication network device 110 can wait for a period of time to determine whether the user's electronic device is connected to the connection port P21 and to determine whether the connection port P21 is connected to the connection port P11.

In operation S203, it is determined whether the network connection is established. When the user's electronic device is connected to the connection port P21 and the connection port P21 is connected to the connection port P11, it represents that the network connection is established. When the network connection is established (the determination result of operation S203 is “YES”), it enters operation S204. When the network connection is not established (the determination result of operation S203 is “NO”), it returns to operation S202 to continue waiting for the network connection to be established.

In operation S204, the noise monitor 1111 and the rate controller 1112 are turned on. Then, it enters operation S205.

In operation S205, the noise monitor 1111 monitors the environmental noise and quantifies the environmental noise to generate the noise result NR. Taking the online conference as an example, multiple users can connect their electronic devices to the connection ports P21-P2N to participate in the online conference. However, when a user is offline or is online, the environmental noise will change. Taking the connection port P11 as an example (other connection ports have similar contents), the noise monitor 1111 can monitor the environmental noise for the connection port P11 in real time and quantify the monitored environmental noise to generate the noise result NR. Then, the noise monitor 1111 can transmit the noise result NR to the rate controller 1112.

The aforementioned environmental noise can be in-band noise or out-of-band noise. The in-band noise can reflect the difference between the original modulated signal and the actual received and equalized signal. The out-of-band noise can reflect the high frequency part of the continuous sampling points (after spectral conversion) sampled by a high-sampling-rate analog-to-digital converter. However, the environmental noise in the present disclosure is not limited to the two types of noise.

In operation S206, the rate controller 1112 determines whether the noise result NR is higher than a deceleration threshold value or lower than an acceleration threshold value.

It is assumed that the current network environment allows the connection port P11 to use a first candidate rate, a second candidate rate, a third candidate rate, a fourth candidate rate, and a fifth candidate rate (ordered from low rate to high rate) for connection (data transmission).

When the connection port P11 is connected at different current rates, the aforementioned candidate rates will correspond to different acceleration/deceleration threshold values. For example, when the current rate of the connection port P11 is the second candidate rate, the acceleration/deceleration threshold values of the first candidate rate, the third candidate rate, the fourth candidate rate, and the fifth candidate rate are a first (deceleration) threshold values, a second (acceleration) threshold value, a third (acceleration) threshold value, and a fourth (acceleration) threshold value respectively. When the current rate of the connection port P11 is the fourth candidate rate, the acceleration/deceleration threshold values of the first candidate rate, the second candidate rate, the third candidate rate, and the fifth candidate rate are a fifth (deceleration) threshold value, a sixth (deceleration) threshold value, a seventh (deceleration) threshold value, and an eighth (acceleration) threshold value respectively.

In some embodiments, the first (deceleration) threshold value, the second (acceleration) threshold value, the third (acceleration) threshold value, and the fourth (acceleration) threshold value are different from the fifth (deceleration) threshold value, the sixth (deceleration) threshold value, the seventh (deceleration) threshold value, and the eighth (acceleration) threshold value.

For example, it is assumed that the current network environment allows the connection port P11 to use the candidate rates of 100 M bit rate, 1 G bit rate, 2.5 G bit rate, 5 G bit rate, and 10 G bit rate.

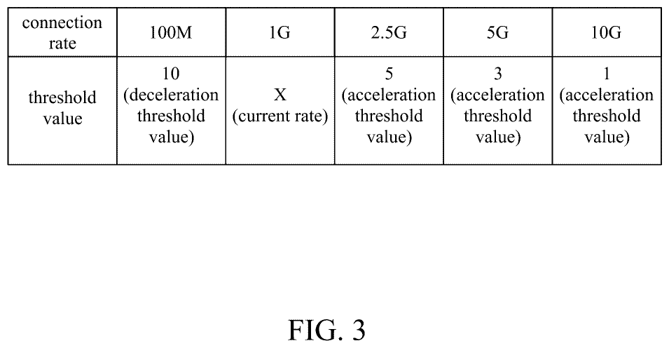

Reference is also made to FIG. 3. FIG. 3 is a schematic diagram of a plurality of threshold values according to some embodiments of the present disclosure. When the current rate of the connection port P11 is 1 G bit rate, the deceleration threshold value for decreasing to 100 M bit rate can be 10, the acceleration threshold value for increasing to 2.5 G bit rate can be 5, the acceleration threshold value for increasing to 5 G bit rate can be 3, and the acceleration threshold value for increasing to 10 G bit rate can be 1.

When the noise result NR is 0.8, the rate controller 1112 determines that the noise result NR is lower than the acceleration threshold value of 2.5 G bit rate, lower than the acceleration threshold value of 5 G bit rate, and lower than the acceleration threshold value of 10 G bit rate. Accordingly, the rate controller 1112 determines that the three bit rates are connectable rates. Then, it enters operation S207.

In operation S207, the rate controller 1112 determines to increase the connection rate. Since 10 G bit rate is greater than 5 G bit rate and is greater than 2.5 G bit rate, the rate controller 1112 selects 10 G bit rate and increases the connection rate of the connection port P11 from 1 G bit rate to 10 G bit rate in subsequent operations.

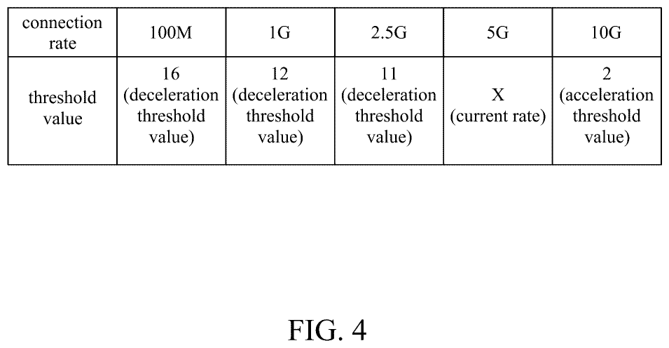

It returns to operation S206. Reference is also made to FIG. 4. FIG. 4 is a schematic diagram of a plurality of threshold values according to some embodiments of the present disclosure. When the current rate of the connection port P11 is 5 G bit rate, the deceleration threshold value for decreasing to 100 M bit rate can be 16, the deceleration threshold value for decreasing to 1 G bit rate can be 12, the deceleration threshold value for decreasing to 2.5 G bit rate can be 11, and the acceleration threshold value for increasing to 10 G can be 2.

When the noise result NR is 15, the rate controller 1112 determines that the noise result NR is higher than the deceleration threshold value of 2.5 G bit rate and is higher than the deceleration threshold value of 1 G bit rate. Accordingly, the rate controller 1112 determines that the two bit rate are connectable rate. Then, it enters operation S208.

In operation S208, the rate controller 1112 determines to decrease the connection rate. Since 1 G bit rate is less than 2.5 G bit rate, the rate controller 1112 selects 1 G bit rate and decreases the connection rate of the connection port P11 from 5 G bit rate to 1 G bit rate in subsequent operations.

After the determinations of operation S207 and operation S208, the connection port P11 is disconnected at first.

In operation S209, the noise monitor 1111 and the rate controller 1112 are turned off.

Then, it returns to operation S202 to wait for the network connection to be established again. To be more specific, the rate controller 1112 controls the connection port P11 to be connected to the connection port P21 at a new connection rate and uses the new connection rate as a new current connection rate for data transmission and noise monitoring.

When the connection rate is greater, the data transmission volume (throughput) between the connection port P11 and the connection port P21 increases. When the connection rate is less, the data transmission volume (throughput) between the connection port P11 and the connection port P21 decreases. The data transmission volume (throughput) can be bits per second or bytes per second.

It returns to operation S206. When the determination of operation S206 is “NO”, it returns to operation S205 to continue monitoring the environmental noise. In other words, when the rate controller 1112 determines that the noise result NR is not higher any deceleration threshold value and is not lower than any acceleration threshold value, the rate controller 1112 does not adjust the connection rate of the connection port P11.

In some related approaches, when the environmental noise in the communication network changes (e.g., when the user is offline or is online), the connection rate cannot be adjusted in real time. This will affect the connection quality and performance of the communication network.

Compared to the related approaches above, the present disclosure can monitor the environmental noise for a connection port, and adjust the connection rate of the connection port according to the quantified noise results. Accordingly, when the environmental noise of the communication network changes, it can adjust the connection rate of the communication network in real time to ensure the connection quality and performance of the communication network.

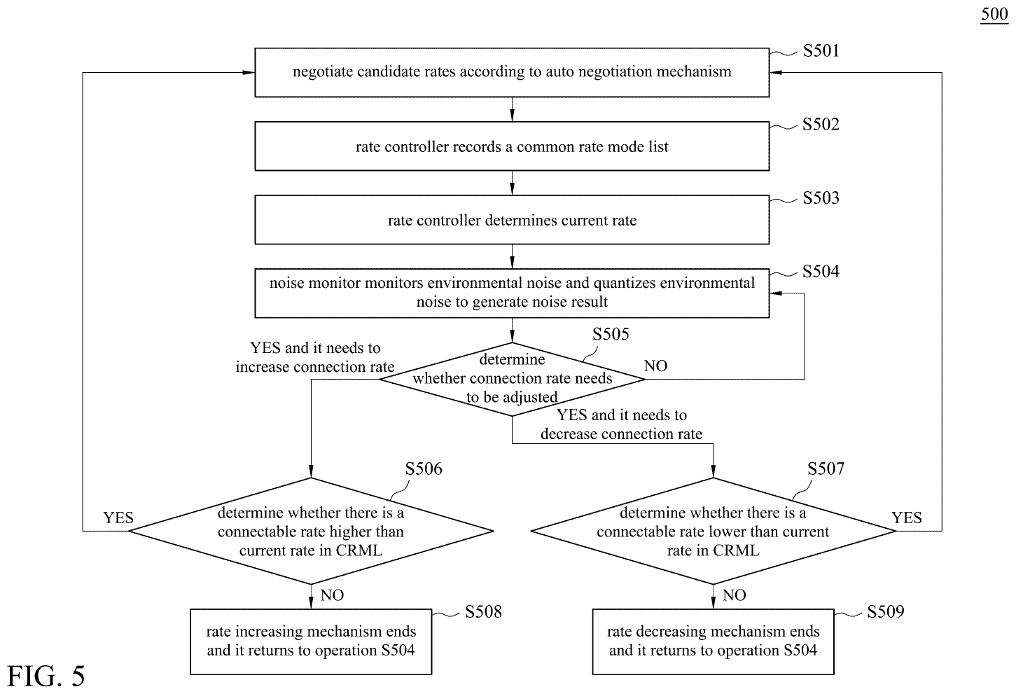

Reference is made to FIG. 5. FIG. 5 is a flow diagram of a rate adjustment method 500 according to some embodiments of the present disclosure.

In some embodiments, the rate adjustment method 500 can be applied to the communication network system 100 and is suitable for the Ethernet environment. For better understanding, the rate adjustment method 500 are described in following paragraphs with reference to the communication network system 100 and the connection port P11 is taken as an example. Other connection ports have similar contents.

As illustrated in FIG. 5, the rate adjustment method 500 includes operation S501, operation S502, operation S503, operation S504, operation 8505, operation S506, operation S507, operation S508, and operation S509.

In operation S501, the communication network device 110 and the communication network device 120 negotiates candidate rates according to auto negotiation (AN) mechanism. For example, a user can set the candidate rates that the communication network device 110 can support through a web page in advance, and can set the candidate rates that the communication network device 120 can support through a web page in advance. When the connection port P11 of the communication network device 110 is connected to the connection port P21 of the communication network device 120, the communication network device 110 and the communication network device 120 can communicate with each other through the auto negotiation mechanism to learn what candidate rates that both of the connection port P11 and the connection port P21 can support.

In operation 8502, the rate controller 1112 records a common rate mode list (CRML). For example, the rate controller 1112 can record the candidate rates that both of the connection port P11 and the connection port P21 can support into the common rate mode list. This common rate mode list can be stored into a memory or a register in the communication network device 110.

In operation S503, the rate controller 1112 determines the current rate. For example, the rate controller 1112 can select the highest candidate rate from the common rate mode list to be the current rate of the connection port P11.

In operation S504, similar to operation S205 in FIG. 2, the noise monitor 1111 monitors the environmental noise for the connection port P11 and quantizes the environmental noise to generate the noise result NR.

In operation 8505, the rate controller 1112 determines whether the connection rate of the connection port P11 needs to be adjusted. When the rate controller 1112 determines that the connection rate of the connection port P11 does not need to be adjusted, it returns to operation S504 such that the noise monitor 1111 continue monitoring the environmental noise. When the rate controller 1112 determines that the connection rate of the connection port P11 needs to be increased, it enters operation S506. When the rate controller 1112 determines that the connection rate of the connection port P11 needs to be decreased, it enters operation S507. Details about how to use the threshold values to determine the connectable rates so as to increase or decrease the connection rate of the connection port P11 are similar to those of operation S206, operation S207, and operation S208, so they are not described herein again.

In operation S506, the rate controller 1112 determines whether there is a connectable rate higher than the current rate in the common rate mode list. When the determination of operation S506 is “YES”, it returns to operation S501. Then, the rate controller 1112 controls the connection port P11 and the connection port P21 to be connected at the higher connectable rate through the automatic negotiation mechanism. When the determination of operation S506 is “NO”, it enters operation S508. In operation S508, rate increasing mechanism ends and it returns to operation S504.

In operation S507, the rate controller 1112 determines whether there is a connectable rate lower than the current rate in the common rate mode list. When the determination of operation S507 is “YES”, it returns to operation S501. Then, the rate controller 1112 controls the connection port P11 and the connection port P21 to be connected at the lower connectable rate through the automatic negotiation mechanism. When the determination of operation S507 is “NO”, it enters operation S509. In operation S509, rate decreasing mechanism ends and it returns to operation S504.

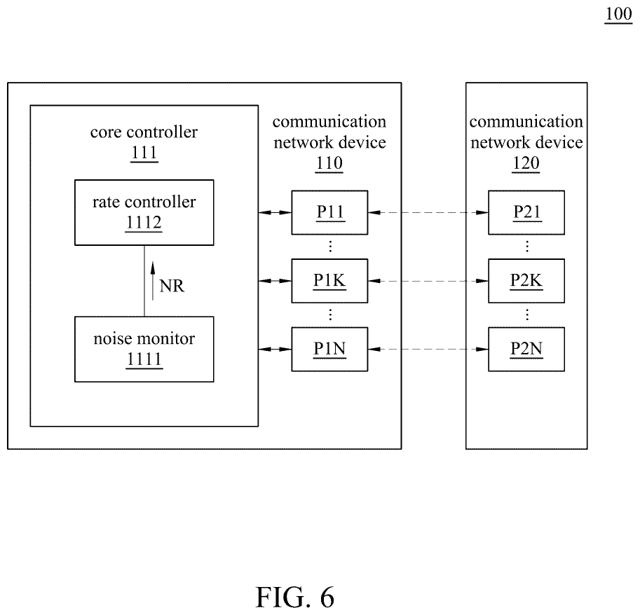

Reference is made to FIG. 6. FIG. 6 is a schematic diagram of how to determine the threshold values for the communication network system 100 in FIG. 1 according to some embodiments of the present disclosure.

As illustrated in FIG. 6, one of the connection ports P11-P1N is called as a target connection port P1K. Following paragraphs describe how to determine threshold values (acceleration threshold values and deceleration threshold values) of the target connection port P1K.

The rate controller 1112 can first control the target connection port P1K to be connected to the connection port P2K at a first rate, and control other connection ports P11-P1N be connected or disconnected to the connection ports P21-P2N at the first rate sequentially. During the sequential connection or disconnection, the rate controller 1112 measures a bit error rate (BER) of the target connection port P1K. When the bit error rate of the target connection port P1K is lower than and closest to the preset maximum allowable value, the rate controller 1112 adjusts (decreases or increases) the connection rate from the first rate to the second rate. Then, the noise monitor 1111 measures the environmental noise for the target connection port P1K at the second rate and quantizes the environmental noise, and the quantized noise result NR is used as the threshold value (the acceleration threshold value and the deceleration threshold value) for adjusting (increasing or decreasing) from the second rate to the first rate.

Taking the acceleration threshold value as an example, the rate controller 1112 can first control the target connection port P1K to be connected to the connection port P2K at 10 G bit rate, and control other connection ports P11-P1N be connected or disconnected to the connection ports P21-P2N at 10 G bit rate sequentially. During the sequential connection or disconnection, the rate controller 1112 measures the bit error rate of the target connection port P1K. It is assumed that the bit error rate of the target connection port P1K is lower than and closest to the preset maximum allowable value when three connection ports are connected. At this time, the rate controller 1112 decreases the connection rate from 10 G bit rate to 2.5 G bit rate under a condition that three connection ports are connected. Then, the noise monitor 1111 measures the environmental noise for the target connection port P1K at 2.5 G bit rate and quantizes the environmental noise, and the quantized noise result NR is used as the acceleration threshold value for increasing from 2.5 G bit rate to 10 G bit rate.

Taking the deceleration threshold value as an example, the rate controller 1112 can first control the target connection port P1K to be connected to the connection port P2K at 2.5 G bit rate, and control other connection ports P11-P1N be connected or disconnected to the connection ports P21-P2N at 2.5 G bit rate sequentially. During the sequential connection or disconnection, the rate controller 1112 measures the bit error rate of the target connection port P1K. It is assumed that the bit error rate of the target connection port P1K is lower than and closet to the preset maximum allowable value when five connection ports are connected. At this time, the rate controller 1112 increases the connection rate from 2.5 G bit rate to 10 G bit rate under a condition that five connection ports are connected. Then, the noise monitor 1111 measures the environmental noise for the target connection port P1K at 10 G bit rate and quantizes the environmental noise, and the quantized noise result NR is used as the deceleration threshold value for decreasing from 10 G bit rate to 2.5 G bit rate.

The aforementioned maximum allowable value of the bit error rate can be predefined in the relevant communication network specifications. The maximum allowable value for different current rates may be different.

By the aforementioned method, the threshold values corresponding to different candidate rates at different current rates can be determined. The communication network device 110 can use these threshold values to adjust the connection rates of the connection ports P11-P1N in real time (e.g., the rate adjustment method 200 in FIG. 2 or the rate adjustment method 500 in FIG. 5).

As described above, the present disclosure can measure the environmental noise for the connection port, and adjust the connection rate of the connection port according to the quantified noise result. Accordingly, when the environmental noise in the communication network changes, the connection rate of the communication network can be adjusted in real time to ensure the connection quality and performance of the communication network.

Although the present disclosure has been described in considerable detail with reference to certain embodiments thereof, other embodiments are possible. Therefore, the spirit and scope of the appended claims should not be limited to the description of the embodiments contained herein. It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A communication network device, comprising:
at least one first connection port; and
a core controller coupled to the at least one first connection port and comprising:
a noise monitor configured to monitor an environmental noise for the at least one first connection port to generate a noise result; and
a rate controller configured to adjust a connection rate of the at least one first connection port according to the noise result.

2. The communication network device of claim 1, wherein the rate controller compares the noise result and a plurality of threshold values corresponding to a current rate to determine at least one connectable rate from a plurality of candidate rates, and adjusts the connection rate from the current rate to the at least one connectable rate.

3. The communication network device of claim 2, wherein a plurality of first threshold values corresponding to a first current rate are different from a plurality of second threshold values corresponding to a second current rate.

4. The communication network device of claim 2, wherein the plurality of threshold values comprise at least one acceleration threshold value, wherein when the noise result is lower than the at least one acceleration threshold value, the rate controller increases the connection rate from the current rate to the at least one connectable rate.

5. The communication network device of claim 4, wherein when the at least one connectable rate comprises a first connectable rate and a second connectable rate and the second connectable rate is greater than the first connectable rate, the rate controller increases the connection rate from the current rate to the second connectable rate.

6. The communication network device of claim 2, wherein the plurality of threshold values comprise at least one deceleration threshold value, wherein when the noise result is higher than the at least one deceleration threshold value, the rate controller decreases the connection rate from the current rate to the at least one connectable rate.

7. The communication network device of claim 6, wherein when the at least one connectable rate comprises a first connectable rate and a second connectable rate and the second connectable rate is less than the first connectable rate, the rate controller decreases the connection rate from the current rate to the second connectable rate.

8. The communication network device of claim 2, wherein when the communication network device is connected, through the at least one first connection port, to at least one second connection port of another communication network device, the rate controller records the plurality of candidate rates in a common rate mode list and selects a highest candidate rate from the common rate mode list as the current rate.

9. The communication network device of claim 1, wherein the at least one first connection port comprises a plurality of first connection ports and a target connection port, the rate controller controls the target connection port to be connected at a first rate and the plurality of first connection ports sequentially to be connected or be disconnected, wherein when a bit error rate is lower than and closest to a maximum allowable value, the rate controller adjusts the first rate to a second rate, and the noise monitor monitors the environmental noise for the target connection port at the second rate to generate a threshold value from the second rate to the first rate.

10. The communication network device of claim 1, wherein the communication network device is a network switch.

11. A rate adjustment method, comprising:
monitoring, by a noise monitor in a core controller in a communication network device, an environmental noise for at least one first connection port to generate a noise result; and
adjusting, by a rate controller in the core controller, a connection rate of the at least one first connection port according to the noise result.

12. The rate adjustment method of claim 11, further comprising:
comparing, by the rate controller, the noise result and a plurality of threshold values corresponding to a current rate to determine at least one connectable rate from a plurality of candidate rates; and
adjusting, by the rate controller, the connection rate from the current rate to the at least one connectable rate.

13. The rate adjustment method of claim 12, wherein a plurality of first threshold values corresponding to a first current rate are different from a plurality of second threshold values corresponding to a second current rate.

14. The rate adjustment method of claim 12, wherein the plurality of threshold values comprise at least one acceleration threshold value, wherein the rate adjustment method further comprises:
increasing, by the rate controller, the connection rate from the current rate to the at least one connectable rate when the noise result is lower than the at least one acceleration threshold value.

15. The rate adjustment method of claim 14, further comprising:
when the at least one connectable rate comprises a first connectable rate and a second connectable rate and the second connectable rate is greater than the first connectable rate, increasing, by the rate controller, the connection rate from the current rate to the second connectable rate.

16. The rate adjustment method of claim 12, wherein the plurality of threshold values comprise at least one deceleration threshold value, wherein the rate adjustment method further comprises:
decreasing, by the rate controller, the connection rate from the current rate to the at least one connectable rate when the noise result is higher than the at least one deceleration threshold value.

17. The rate adjustment method of claim 16, further comprising:
when the at least one connectable rate comprises a first connectable rate and a second connectable rate and the second connectable rate is less than the first connectable rate, decreasing, by the rate controller, the connection rate from the current rate to the second connectable rate.

18. The rate adjustment method of claim 12, further comprising:
recording, by the rate controller, the plurality of candidate rates in a common rate mode list when the communication network device is connected, through the at least one first connection port, to at least one second connection port of another communication network device; and
selecting, by the rate controller, a highest candidate rate from the common rate mode list as the current rate.

19. The rate adjustment method of claim 11, wherein the at least one first connection port comprises a plurality of first connection ports and a target connection port, wherein the rate adjustment method further comprises:
controlling, by the rate controller, the target connection port to be connected at a first rate and the plurality of first connection ports sequentially to be connected or be disconnected;
adjusting, by the rate controller, the first rate to a second rate when a bit error rate is lower than and closest to a maximum allowable value; and
monitoring, by the noise monitor, the environmental noise for the target connection port at the second rate to generate a threshold value from the second rate to the first rate.

20. The rate adjustment method of claim 11, wherein the communication network device is a network switch.
